(19) United States
(12) Patent Application Publication
(10) Pub. No.: US 2003/0113406 A1
(43) Pub. Date: Jun. 19, 2003

(54) Tea manufacture

(75) Inventors: Tanuja Venugopal Rao, Bangalore (IN); Prakash Dattatraya Virkar, Bangalore (IN); Pratyaya Chakrabarti, Bangalore (IN); Ravi Mohan, Tamil Nadu (IN); Suri Krishna Mohan, Bangalore (IN); Jayati Pal, Bangalore (IN)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/237,383

(22) Filed: Sep. 9, 2002

(30) Foreign Application Priority Data
Sep. 12, 2001 (IN) 873/MUM/01
Oct. 31, 2001 (GB) 0126152.8

(51) Int. Cl. A23K 1/00

(52) U.S. Cl. 426/49

(57) ABSTRACT

A process to make tea with higher yields of a desired size comprising the steps of:

(a) withering green leaf tea and optionally other materials

(b) size reduction

(c) fermentation

(d) extrusion of the size reduced or fermented tea leaf mass through holes in a perforated body

(e) cutting the extrudate

(e) drying

The desired size of the tea is preferably Broken Orange Pekoe (BOP), Broken Pekoe (BP) or Broken Orange Pekoe Souchung (BOPS).

The present invention relates to a process for making a black leaf tea product of a desired size and shape. More particularly, the invention relates to a process to make a black leaf tea product in which the proportion of the product having a larger particle size is increased.

### BACKGROUND TO THE INVENTION

Methods of preparing black leaf teas are well-known to those skilled in the art. Generally, to prepare black leaf tea, fresh green leaves of the plant Camellia sinensis are subjected to mild drying (the withering stage), are processed to reduce the size of the leaf and to disrupt the cell structure (the size reducing stage), fermented (in which process enzymes in the tea leaf use atmospheric oxygen to oxidise various substrates to produce brown-coloured products) and then fired (to dry the tea leaves). Depending on the particular process used, particularly at the size reducing stage, different grades of tea are produced. Processes in which the size reduction of the withered green leaf tea is performed by an orthodox roller or a rotovane tend to give larger leaf sizes in the black leaf tea product than processes in which the withered leaf tea is treated more dratically for example in a CTC (cut-tear-curl) process. Orthodox manufacture tends to give grades a black tea product which are graded as Whole Leaf grades whereas the use of the rotovane tends to give a black tea product that is graded as Brokens and CTC tends to give a black tea product which is graded as Fannings. See “tea—Cultivation to Consumption” edited by K. C. Willson and M. N. Clifford, Chapman and Hall, 1992 page 501. Black leaf tea with a larger particle size is considered a premium tea and commands a higher price than the smaller grades (Fannings and Dusts). All the above processes however give significant amounts of smaller grades of tea.

Typically, a process as usually employed in the tea industry yields a maximum of 60% of black leaf tea product having the desired larger particle size. It is an object of the present invention to provide black leaf tea product in which the proportion of the product having a larger particle size is increased. Preferably the proportion of the black leaf tea product which would be graded as Brokens is increased. More specifically the proportion of the black leaf tea graded as Broken Orange Pekoe (BOP), Broken Pekoe (BP) and/or Broken Orange Pekoe Souchung (BOPS) is increased.

SU 526339 discloses a process of making tea which involves the steps of withering, rolling, grading, comminuting, treating with a sugar solution, drying to a moisture content of 35-50%, granulating and drying to give tea granules of about 5 mm diameter.

The prior art therefore does teach a process which can be used to obtain black tea having a larger particle size but it requires the use of sugar as a granulating aid thus giving a product that contains non-tea material.

### STATEMENT OF THE INVENTION

In the first aspect of the invention, there is provided a process to make a black leaf tea product with higher yields of a desired larger particle size comprising the steps of:

a. withering green leaf tea

b. reducing the size of the withered green leaf tea

c. fermentation

d. extrusion of the size reduced or fermented tea leaf mass through the holes in a perforated body

e. cutting the extrudate

f. drying to give the black tea product

In a preferred embodiment the extrusion step occurs after the fermentation step.

Preferably the desired grade of the black leaf tea product is Fannings more preferably Broken Orange Pekoe (BOP), Broken Pekoe (BP) and/or Broken Orange Pekoe Souchung (BOPS).

In a second aspect of the present invention the extrudate is shaped, for example into a substantially spherical shape or into a long leaf shape, using a suitable device. The shaping step is preferably carried out after the cutting step but before the drying step.

In a further aspect of the invention, there is provided a black leaf tea product prepared by the process of the invention.

“Tea” for the purposes of the present invention means leaf material from Camellia sinensis var. sinensis or Camellia sinensis var. assamica. It also includes rooibos tea obtained from Aspalathus linearis however that is a poor source of endogenous fermenting enzymes. “Tea” is also intended to include the product of blending two or more of any of these teas.

“Leaf tea” for the purposes of this invention means a tea product that contains one or more tea origins in an uninfused form.

For the avoidance of doubt the word “comprising” is intended to mean including but not necessarily “consisting of” or “composed of”. In other words the listed steps or options need not be exhaustive.

Except in the operating and comparative examples, or where otherwise explicitly indicated, all numbers in this description indicating amounts or concentrations of material ought to be understood as modified by the word “about”.

### DETAILED DESCRIPTION OF THE INVENTION

All parts herein are by weight unless otherwise specified.

The present invention provides for a process to make a black leaf tea of a required size comprising the steps of:

a. withering green leaf tea and optionally other materials

b. size reduction

c. fermentation

d. extrusion of the size reduced or fermented tea leaf mass through holes in a perforated body

e. cutting the extrudate

f. drying

In the process of the invention, plucked green tea leaves are first subjected to a withering step during which the moisture content of the tea leaves is preferably reduced from 80 to 60%. Withering is a process whereby the plucked tea leaves are stored for periods of time (perhaps up to 24 hours), during which they undergo various biochemical and physical changes which often includes a loss of moisture. Typically, this is carried out by blowing air across a bed of green tea leaves.

The withering step is followed by a size reductions step (often referred to in the art as a maceration or comminution step) during which the withered green tea leaf is reduced in size. During size reduction, the cell wall is ruptured allowing the cell contents to react. Size reduction can be carried out by any of the methods known in the art including cut-tear-curl (CTC), rolling (as in the orthodox process), use of a rotovane or use of a Lawrie tea processor etc. The size reduction step can be followed by the fermentation step or by the extrusion and cutting step.

The term “fermentation” is used commonly in the tea business but it is a misnomer. “Fermentation” is commonly used in the context of brewing alcohol to describe the action of exogenous enzymes. However in the tea world it is used to refer to the oxidative process that tea undergoes when certain endogenous enzymes and substrates are brought together by mechanical disruption of the cells for example by tearing or cutting the leaves. During this process colourless catechins in the leaves are converted to a complex mixture of yellow and orange to dark-brown substances and producing a large number of aromatic volatile compounds. The colourful oxidation products include theaflavins and thearubigens. Theaflavins comprise several well-defined catechin condensation products that are characterised by their benzotropolone ring. Thearubigens are a group of undefined molecules with a large variance in molecular weight. They have a large variety of colours ranging from yellow to dark red and brown.

Fermentation is suitably carried out by contacting the leaf tea material with air or an oxygen enriched gaseous mixture. It is also possible to carry out size reduction, followed by partial fermentation, followed by further reduction and complete fermentation.

The extrusion step can be suitably carried out after size reduction or fermentation (preferably after fermentation). The size reduced or fermented mass comprising tea leaf material and moisture is extruded in apparatus that forces the material through holes in a perforated body which may be in the form of a perforated sheet or mesh. The size of the perforations in the perforated sheet or the mesh size is chosen so as to obtain tea of the required size and shape. Thus, by selecting the perforated sheet or mesh, it is possible to obtain a wide range of sizes of the tea produced. Also, the shape of perforation can be changed to produce a black leaf tea with different appearances. The extruder used may be an axial extruder in which the the extrudate emerges in the same direction as the axis or the extruder or a radial extruder in which the extrudate emerges radially to the axis of the extruder.

In a preferred form of extruder for use in the present invention the size reduced or fermented mass is pushed through the holes in the perforated body by an impeller that passes over the surface of the perforated body remote from that from which the extrudate emerges. In a particularly preferred axial extruder, the perforated body is a cylindrical perforated sheet or mesh and the impeller is a blade or roller that rotates inside the cylindrical perforated sheet or mesh passing over its inner surface and forcing the tea mass to be extruded through the holes. In an alternative embodiment the blade or roller is located at a fixed position inside the cylindrical perforated sheet or mesh and the cylindrical sheet or mesh is rotated.

Preferably the extruder is a low pressure extruder. In such extruders, it is preferred that the pressure is not more than 15 bar. In preferred extruders used in the invention, the mass of material to be extruded is fed thorough the extruder by a screw feeder for positive displacement of the mass.

The extruded mass comprising the tea leaf material is then cut to a suitable size by any appropriate means. It is preferred that the cutting take place immediately after extrusion. It is not necessary to provide for a separate cutting means and in a preferred aspect, it is possible to provide for an extruder integrally fitted with a cutter.

Optionally, the extruded and cut material can be shaped by using any suitable shaping device. For example, for substantially spherical tea appearance, a tumbling device like a drum is used. Other shapes like orthodox type long leaf can also be obtained.

The product is fired and dried to give a black leaf tea product. The firing involves heating and drying the tea to destroy the fermenting enzymes and thereby arrest fermentation. It results in a reduction of moisture content to below 5%, and also leads to further chemical oxidation and changes in tea aroma. Drying methods include tray drying, fluidised bed drying, vibratory fluidised bed drying etc. In a preferred aspect the tea leaf material is dried by first tray drying followed by fluidised bed drying.

The tea of required size prepared by the process of the invention is obtained in a higher yield. For example, by using the process of the invention, the yield of a larger desired grade can be increased by at least 10%. The amount of secondary grade teas in the dried tea is significantly lower than that obtained by the conventional process.

Other optional materials can be added at any stage during the process of the invention. These include secondary teas, dust tea, enzymes, flavours, encapsulated flavours, other leaf/flower material like jasmine, mint and/or basil, starches, carbohydrates, etc. The optional materials may also be added to the teas or tea blends prepared by the process of the invention.

The tea prepared by the process of the invention can be sold as such or packed and sold. The tea prepared by the process of the invention can also be blended with other teas and sold.

The invention will now be illustrated by the following non-limiting examples.

### EXAMPLES

### Comparative Examples A to D

Approximately 3 kgs of plucked green tea leaf was withered at ambient conditions. The withered leaf was given four cuts on the Cut-Tear-Curl (CTC) machine. The material was kept for fermentation for 60 minutes. The fermented material obtained, “dhool”, was then fired in a drier. The moisture of the fermented dhool was measured and recorded. The material so obtained was sieved and graded into BOPS, BOP, BP, Fannings and Dust grades. The percentage yield of the BOPS and BP grades was also determined and the percentage yield of total leaf grade was determined.

The experiment was repeated with varying degrees of wither, thus giving fermented dhool of varying moisture levels.

### Examples 1-4

The control processes for examples 1-4 were Comparative examples A-D respectively.

Approximately 2 kgs of plucked tea leaf was withered at ambient conditions. The withered leaf was given four cuts on the CTC machine. The material was kept for fermentation for 55 minutes. The moisture of the fermented dhool was measured and recorded. The fermented dhool was passed through the extruder. Under steady operating conditions the output from the extruder unit was collected. This was then fired in a drier. The material so obtained was sieved and graded into BOPS, BOP, BP, fannings and dust grades.

The experiment was repeated with varying degrees of wither (thus giving fermented dhool of varying moisture levels).. In examples 1-3 axial extrusion was employed, whereas in example 4, radial extrusion was employed. The perforation size of the extruder was 2.5 mm diameter. The RPM of the radial extruder was kept constant at 12 for the entire set of experiments. By axial extrusion is meant that the extrudate is taken out in the same direction as the axis of the extruder. By radial extrusion is meant that the extrudate is taken out radially to the axis of the extruder.

The details of the processes of Comparative examples A-D and examples 1-4 and the tea thereby obtained are presented in Table 1.

TABLE 1

| | Perforation size | Dhool | Yield of | Yield of |
|---|---|---|---|---|
| | of extruder | Moisture | BOPS and | Total Leaf |
| Example | (mm) | (%) | BOP (%) | (%) |
| A | No extrusion | 71.4 | 14.6 | 39.8 |
| B | No extrusion | 69 | 22.7 | 25.9 |
| C | No extrusion | 68.3 | 9.3 | 45.6 |
| D | No extrusion | 61.5 | 5.0 | 18.4 |
| 1 | 2.5 | 71.4 | 78.3 | 93.4 |
| 2 | 2.5 | 69 | 81.6 | 97.4 |
| 3 | 2.5 | 68.3 | 58.3 | 89.6 |
| 4 | 2.5 | 61.5 | 58.9 | 87.2 |

The data presented in Table 1 demonstrated that using the process of the invention, tea of a particular required size and shape can be obtained in a high yield.

### Examples 5-8

The process of Examples 1-4 were repeated except that the perforation size of the extruder was changed. The details of the same as well as the tea obtained by the process are presented in Table 2.

TABLE 2

| | Perforation | | | | |
|---|---|---|---|---|---|
| | size (mm) | Dhool | Yield of | | Yield of |
| Exam- | (extrusion | Moisture | BOPS and | Yield of | Total |
| ple | type) | (%) | BOP (%) | BP (%) | Leaf (%) |
| 5 | 4.5 mm (Axial) | 64.0 | 92.1 | 4.6 | 96.7 |
| 6 | 3 mm (Axial) | 65.0 | 74.4 | 9.3 | 83.7 |
| 7 | 2.5 mm (Axial) | 60.5 | 66.3 | 19.2 | 85.4 |
| 8 | 2.5 mm (Radial) | 61.5 | 58.9 | 28.4 | 87.2 |

Thus, by changing the perforation size, the size distribution of the tea granules can be changed. The perforation size is an important parameter for optimising the yields of a particular desired size.

Evaluation of Tea:

I. Infusion studies were carried out on the BOP grade of tea prepared by the process of Comparative Example D and Example 4. The percentage soluble solids in the tea liquor were determined.

6 cups with 200 ml freshly boiled water in each cup were taken. 4 g of BOP grade tea of Comparative Example D was added to each cup. The tea was allowed to brew. The procedure was repeated with BOP grade of the tea of Example 4.

One cup of the liquor prepared from the BOP grade tea of Comparative Example D, was removed after one minute and the tea was strained out. The tea liquor was cooled to 25 degree centigrade. The procedure was repeated every minute for a total period of 6 minutes.

The procedure was repeated for the BOP grade tea of example 4.

II. The Total Soluble Solids (TSS) in each of the tea cups was then measured. TSS was measured as follows:

A dry dish was weighed (W1). To this was added 50 ml of a filtered infusion from the tea cup prepared as mentioned above. The temperature of the infusion was 25 degrees centigrade. The water was evaporated over a water bath. The dish was then kept in an oven maintained at 100 deg C. (±5 deg C.) overnight for 16 hours. The dish was then cooled in a dessicator and the weight recorded (W2). TSS was then determined as follows.

TSS=W2−W1

The procedure was repeated for each of the infusions prepared.

The data is presented in Table 3.

TABLE 3

| | |
|---|---|
| Comparative | |
| Example D | Example 4 |

| | |
|---|---|
| Time (minutes) | TSS (gms/50 ml) |

| | | |
|---|---|---|
| 0 | 0 | 0 |
| 1 | 0.1697 | 0.119 |
| 2 | 0.213 | 0.1739 |
| 3 | 0.2214 | 0.1999 |
| 4 | 0.2331 | 0.2192 |
| 5 | 0.2476 | 0.2346 |
| 6 | 0.2466 | 0.2454 |

The results of Table 3 show that there is no significant change in the total soluble solids of the tea infusion by carrying out the process of the invention. The tea infusion prepared by the process of the invention has similar characteristics to a tea prepared by the conventional process.

III. The BOP grade tea of Comparative example D and Example 4 were evaluated by a trained panel of 12 members. No significant difference in the quality of the tea prepared by the conventional process and the process of the invention was perceived. The results are presented in Table 4.

TABLE 4

| | Comparative | |
|---|---|---|
| Attribute | Example D | Example 4 |
| Color | 5.63 | 5.61 |
| Brightness | 5.58 | 5.68 |
| Red | 0.72 | 0.76 |
| Yellow | 1.21 | 1.28 |
| Brown | 3.61 | 3.62 |
| Tea Aroma | 3.30 | 3.33 |
| Green Aroma | 3.42 | 3.42 |
| Fresh Aroma | 3.33 | 3.38 |
| Tea Flavour | 3.55 | 3.59 |
| Green Flavour | 3.47 | 3.48 |
| Fresh flavour | 3.46 | 3.53 |
| Body | 3.95 | 3.94 |
| Tea Taste | 3.73 | 3.74 |
| Bitter Taste | 1.15 | 1.24 |
| Tea After Taste | 3.37 | 3.37 |
| Bitter After Taste | 1.15 | 1.21 |
| Astringency | 4.79 | 4.76 |

Thus the process of the invention provided for a process of obtaining tea of a desirable size and shape in high yields. The teas obtained by the process have good characteristics and are comparable to teas made by the conventional process.

1) A process to make a black leaf tea product with higher yields of a desired larger particle size comprising the steps of:
a) withering green leaf tea
b) reducing the size of the withered green leaf tea
c) fermentation
d) extrusion of the size reduced or fermented tea leaf mass through holes in a perforated body
e) cutting the extrudate
f) drying to give the black tea product

2) A process as claimed in claim 1 wherein the extrudate is shaped after the cutting step.

3) A process as claimed in claim 2 wherein the extrudate is shaped into a substantially spherical shape or into a long leaf shape

4) A process as claimed in claim 1 wherein the particle size of the black leaf tea product is Broken Orange Pekoe (BOP), Broken Pekoe (BP) and/or Broken Orange Pekoe Souchung (BOPS).

5) A process as claimed in claim 1 wherein the extrusion takes place in a low pressure extruder

6) A process as claimed in claim 1 wherein the extrusion step takes place in an extruder in which the size reduced or fermented mass is pushed through the holes in a perforated by an impeller that passes over the surface of the perforated body remote from that from which the extrudate emerges.

7) A process as claimed in claim 6 wherein the extruder is an axial extruder, the perforated body is a cylindrical perforated sheet or mesh and the impeller is a blade or roller that rotates inside the cylindrical perforated sheet or mesh passing over its inner surface and forcing the tea mass to be extruded through the holes

8) A process as claimed in any preceding claim wherein the extrusion step occurs after the fermentation step.

9) A leaf tea of size Broken Orange Pekoe (BOP), Broken Pekoe (BP) and/or Broken Orange Pekoe Souchung (BOPS) prepared by the process of claim 1.
